(19) United States
(12) Patent Application Publication
(10) Pub. No.: US 2011/0198161 A1
(43) Pub. Date: Aug. 18, 2011

(54) MASTER BRAKING SYSTEM AND METHOD THEREFOR

(76) Inventor: Louis Lomazzo, Hesperia, CA (US)

(21) Appl. No.: 12/858,215

(22) Filed: Aug. 17, 2010

Related U.S. Application Data
(60) Provisional application No. 61/337,894, filed on Feb. 12, 2010.

(51) Int. Cl. B60T 1/14

(52) U.S. Cl. 188/5

(57) ABSTRACT

A master braking system provides enhanced braking capabilities to various types of vehicles. The master braking system may utilize one or more braking pads that enlarge the contact surface between a vehicle and the road surface as compared to the vehicles tires. The master braking system may comprise an actuator powered by a power source and controlled by a control module. When deployed, a braking pad contacts the road surface to quickly slow or stop a vehicle. The braking pad may then be retracted to allow the vehicle to move freely once again.

### CROSS-REFERENCE TO RELATED APPLICATION

This application claims priority from U.S. Provisional Patent Application No. 61/337,894 entitled Master Brake, filed Feb. 12, 2010.

### BACKGROUND OF THE INVENTION

1. Field of the Invention

The invention relates to vehicle braking systems, particularly to a supplemental vehicle braking system and method.

2. Related Art

A motor vehicle requires a propulsion system and a stopping mechanism to be useful and safe for its occupants. Traditionally, motor vehicles braking systems stop or slow down by acting on the vehicles wheels to reduce their rotation. The friction between the wheels and the road or other surface thus causes the motor vehicle to slow or to stop.

Oftentimes, the speed and/or weight of the motor vehicle are such that its braking system can not stop the vehicle within a desired or necessary distance. This is especially so where the motor vehicle has a substantial weight or is towing or hauling a load.

Moreover, the propulsion system or engine of a motor vehicle typically has sufficient power to overcome the braking system of the motor vehicle, including sometimes, the motor vehicle's emergency brake. In the case of an engine malfunction, the motor vehicle's acceleration, speed, or both may be uncontrollable, leading to an extremely hazardous situation.

From the discussion that follows, it will become apparent that the present invention addresses the deficiencies associated with the prior art while providing numerous additional advantages and benefits not contemplated or possible with prior art constructions.

### SUMMARY OF THE INVENTION

A master braking system is disclosed herein. In one or more embodiments, the master braking system may supplement the traditional braking system provided by a vehicle. The master braking system greatly increases the stopping or slowing capability of a vehicle even in bad road conditions. In fact, vehicles with the master braking system experience a substantial improvement in stopping distance which is highly beneficial in both emergency and ordinary driving situations. The master braking system is capable of providing this improvement even in less than ideal road or environmental conditions. In addition, the master braking system may be incorporated into a vehicle at manufacture or installed after manufacture.

The master braking system may have various configurations. For example, in one embodiment the master braking system may comprise an actuator comprising a deployment member configured to be movable between a retracted position and an extended position at a bottom portion of the vehicle. The deployment member may extend downward from the bottom portion of the vehicle in the extended position. A braking pad configured to slow the vehicle through contact with a road surface may be attached to the deployment member. A reservoir configured to hold pressurized gas therein, and one or more conduits connecting the reservoir to the actuator may be included as well.

At least one input control may be within the vehicle. The input control may be configured to accept user input to release the pressurized gas from the reservoir to the actuator. The input control may be further configured to accept user input to release the pressurized gas from the actuator. A compressor may be configured to provide the pressurized gas to the reservoir. The compressor may be connected to the reservoir by at least one of the conduits.

The actuator may be configured to move the deployment member from the extended position to the retracted position (where the braking pad is not in contact with the road surface in the retracted position). An enclosure may be configured to surround at least a portion of the deployment member where the deployment member extends from a body of the actuator. A support having a peripheral size larger than the deployment member may be between the deployment member and the braking pad. It is noted that the braking pad may have a peripheral size larger than the deployment member.

In another exemplary embodiment, the master braking system may comprise an actuator comprising a deployment member configured to be movable between a retracted position and an extended position at a bottom portion of the vehicle. The deployment member may extend downward from the bottom portion of the vehicle in the extended position. The actuator may be mounted a various locations on the vehicle. For example, the actuator may be centrally mounted at the bottom portion of the vehicle, or be mounted at a rear end of the vehicle. The master braking system may also include a power source configured to power the actuator by providing energy (e.g., pneumatic energy, hydraulic energy, or electrical energy).

A braking pad may be attached to the deployment member. The braking pad may be configured to convert the vehicle's motion into heat and friction via contact with a road surface, and to provide an increased contact surface area between the vehicle and the road surface relative to a contact surface area provided by one or more tires of the vehicle and the road surface. The master braking system may also have an input control configured to cause the deployment member to extend downward from the bottom portion of the vehicle to produce contact between the braking pad and the road surface.

An enclosure may enclose at least a portion of the deployment member where the deployment member extends from a body of the actuator. The enclosure may enclose the braking pad and comprise a bottom configured to open as the deployment member extends downward from the bottom portion of the vehicle.

It is contemplated that the master braking system may be used with various types of vehicles. For example, the vehicle may be a car, truck, bike, trailer, or other on or off road vehicle.

Various methods for slowing a vehicle are also provided. For example, a method for slowing a vehicle may comprise providing a braking pad in a retracted position, receiving an input indicating that the braking pad must be deployed, extending a deployment member downward from the bottom portion of the vehicle to deploy the braking pad, contacting a road surface with the braking pad, and applying a force to the road surface through the braking pad and deployment member to slow the vehicle. Extending the deployment member may comprise sending pressurized gas from a reservoir to the actuator. The reservoir may be pressurized by forcing gas into the reservoir.

The braking pad may be attached to a deployment member of an actuator at the bottom portion of the vehicle. The braking pad may be removed from a bottom end of the deployment member and attaching a new braking pad to the bottom end of the deployment member. The braking pad may be protected in the retracted position with an enclosure configured to form a barrier around the braking pad.

The deployment member may also be retracted to the retracted position to raise the braking pad off the road surface. An input indicating that the braking pad must be retracted may be received prior to retracting the braking pad.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1A is a perspective view of a first exemplary embodiment of the master braking system;

FIG. 1B is a perspective view of a second exemplary embodiment of the master braking system;

FIG. 1C is a block diagram illustrating components of an exemplary master braking system;

FIG. 2A is a side view of an exemplary actuator and braking material assembly in a retracted position;

FIG. 2B is a side view of an exemplary actuator and braking material assembly in an extended position;

FIG. 3A is a side view of a vehicle showing exemplary locations where components of the master braking system may be installed;

FIG. 3B is a bottom view of a vehicle showing exemplary locations where components of the master braking system may be installed;

FIG. 4A is a side view illustrating an exemplary master braking system in a retracted position relative to a vehicle;

FIG. 4B is a side view illustrating an exemplary master braking system in an extended position relative to a vehicle; and

FIG. 5 is a block diagram illustrating an exemplary control module of the master braking system.

### DETAILED DESCRIPTION OF THE PREFERRED EMBODIMENTS

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

In general, the master braking system herein is configured to slow and/or stop a moving motor vehicle. The master braking system may be used with an existing braking system of a motor vehicle, such as to enhance or supplement the braking force available to slow or stop the motor vehicle. The master braking system may alternatively be used as the primary or only braking system of a motor vehicle in some embodiments. For example, upon failure of the vehicle's traditional braking system, the master braking system may be used. The master braking system may also be used to slow or stop a runaway vehicle.

Traditional braking systems operate on the wheels of a vehicle to slow the vehicle down by reducing the rotation of the vehicle's wheels. The braking force thus relies upon friction between the vehicle's tires and the road or other surface the vehicle is traveling on. As will be described further below, each tire provides only about a six inch contact surface with the road. In certain circumstances, this is insufficient to generate the desired or required braking force, such as to avoid an accident. This is especially so where road conditions reduce the amount of friction that can be generated.

The master braking system is thus highly beneficial in that it may be used to provide a substantially enhanced braking force. This allows a user to stop his or her vehicle within a desirable distance as compared to the stopping distance without the master braking system. In fact, the master braking system can stop a vehicle nearly instantaneously. In addition, as compared to vehicles with state of the art traditional braking systems in ideal conditions, the master braking system provides substantial improvements to stopping distance. This is so even where the vehicle with the master braking system is heavier and in less than ideal conditions (e.g., inclement weather, substantial heat, imperfect roads, inclined roads, etc. . . . ). In this manner, accidents can be avoided and the safety of vehicle occupants greatly increased with the master braking system.

As will be described further below, the advantages of the master braking system can be attained without changing the operation or structure of a vehicle. In fact, though it is contemplated that the master braking system may be included in new vehicles, in one or more embodiments, the master braking system may be an add-on or upgrade to an existing vehicle.

Typically, the master braking system operates by increasing the friction between the vehicle and the road surface in order to supplement or to provide braking force. It is noted that though referred to herein as a road surface, such term may also refer to other surfaces upon which a vehicle drives or moves. As will be described in the following, the master braking system may provide an increased surface area which meets the road when stopping or slowing of a vehicle is desired or required. The master braking system may be easily engaged or deployed, and may also be disengaged and redeployed easily and conveniently.

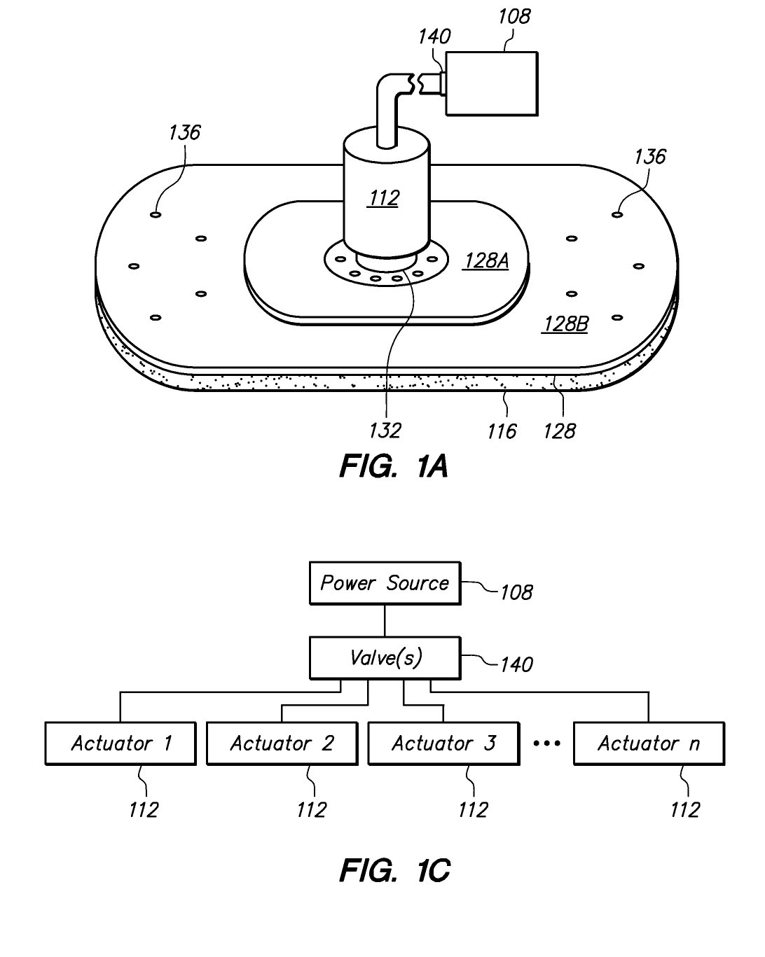

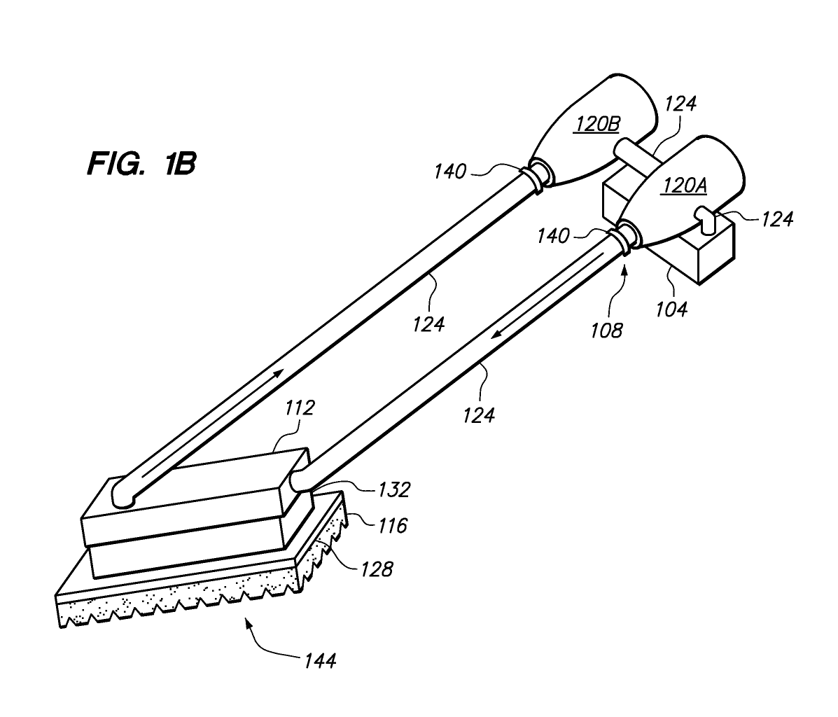

The master braking system will now be described with regard to FIGS. 1A-1B. FIG. 1A illustrates an exemplary master braking system. Generally speaking, the master braking system may comprise an actuator 112, power source 108, and a braking pad 116. The master braking system may also, but need not, include structural support components such as a press plate 128. It is contemplated that one or more of these components may be provided in some embodiments, such as for redundancy or to supplement the capabilities of a component by providing another similar or identical component. For example, multiple actuators 112, power sources 108, and/or braking pads 116 may be provided to increase the force available for braking.

In one or more embodiments, the master braking system deploys a braking pad 116 to generate a braking force between the braking pad and a road surface. The friction generated by the braking pad and the road surface slows down the vehicle. If desired, this friction may also bring the vehicle to a complete stop, hold the vehicle in position, or both. The configuration of the master braking system greatly enhances a vehicle's braking capabilities in one or more embodiments. This permits a driver to rapidly slow or stop a vehicle as compared to traditional braking systems.

The deployment of a braking pad 116 may be achieved in various ways. Typically, an actuator 112 or the like may be used to move the braking pad 116 into contact with a road surface, thus deploying the braking pad 116. As will be described further below, the actuator 112 may move the braking pad 116 such that it comes into contact with the road surface.

The actuator 112 may utilize various mechanisms to deploy the braking pad 116. For example, the actuator 112 may comprise an electrical actuator or motor which, when energized, deploys the braking pad 116. Alternatively, the actuator 112 may utilize one or more biasing devices, such as springs, which, when released, cause the braking pad 116 to be deployed to a road surface. It is contemplated that the braking pad 116 may be of sufficient weight in some embodiments, to be deployed by gravity, such as by releasing the braking pad 116 onto the road surface.

The actuator 112 may be powered by a power source 108 in one or more embodiments. For example, an electrical actuator 112 may have a battery, generator, or other electrical source as its power source 108. The power source 108 may be connected to the actuator 112 by one or more conduits 124 such as shown. The conduits 124 may be elongated, comprise one or more curves, bends, or the like, and be various shapes and sizes. This allows the power source 108 to be placed at various locations on a vehicle relative to the actuator 112.

The actuator 112 may be pneumatically powered in one or more embodiments. For example, the embodiment of FIG. 1A illustrates a pneumatic embodiment utilizing a power source 108 comprising a compressed gas canister or container. Various types of gas may be used. For example, compressed air, nitrous oxide, carbon dioxide, helium, nitrogen, or other gas may be used. The conduit 124 carries the gas from the power source 108 to the actuator 112. Thus, to deploy the braking pad 116, pressurized gas within the power source 108 is rapidly released to the actuator 112. This causes the actuator 112 to extend and deploy the braking pad 116 to a road surface.

Compressed gas may also retract the actuator 112 and braking pad 116 in some embodiments. For example, the actuator 112 may comprise an internal piston. In such embodiment, gas may be released on one side of the piston to deploy piston (i.e., extend the actuator 112). Gas may be released on the opposite side of the piston to move the piston in the opposite direction (i.e., retract the actuator 112). One or more conduits 124 may be used to connect one or more power sources 108 such that gas may be released on opposite ends or sides of the piston. It is noted that though described herein with reference to gas, the actuator 112 may be hydraulically powered in some embodiments, and may accordingly be operated with hydraulic fluid.

One or more valves 140 or the like may be used to release the gas from the power source 108 when deployment of the braking pad 116 is desired. As will be described further below, the valves 140 may be controlled by a driver/user or device activated input or control. In this manner, the master braking system may be controlled by a user or device of the vehicle. Though illustrated nearer to the power source 108, it is noted that the valve 140 may be at various locations. For example, the valve 140 may be at or near the actuator 112 or on the conduit 124 itself.

The braking pad 116 may be secured to the actuator 112 to allow the actuator to move the braking pad to both deploy and retract the braking pad. For example, the braking pad 116 may be deployed by extending the actuator 112 such that the braking pad may move downward towards the road surface. To retract the braking pad 116, the actuator 112 may be retracted upward to move the braking pad away from the road surface. In one or more embodiments, the actuator 112 may comprise a deployment member 132 which is configured to extend and retract from the body of the actuator. The braking pad 116 may be mounted to the actuator's deployment member 132 in one or more embodiments.

The deployment member 132 may be various shapes and sizes. For example, in one embodiment, the deployment member 132 may be an elongated shape. The deployment member 132 may be the same length or longer than the actuator's body. Alternatively, the deployment member 132 may be shorter than the actuator's body. The variety of lengths (and especially longer lengths) allows the deployment member 132 to extend to connect or attach to braking pads 116 at various distances.

The deployment member 132 may be rigidly mounted to the braking pad 116 or may be pivotably or rotatably mounted to the braking pad 116. For example, FIG. 1A illustrates an embodiment having a rigid mount where the actuator's force is applied generally perpendicular to the braking pad 116. A pivoting mount may be used where the actuator 112 is aligned at an angle relative to the braking pad 116. The pivoting mount may allow force provided at an angled force vector to be directed downward to deploy the brake and to apply a downward braking force. It is contemplated that the braking pad 116 may be mounted to the vehicle by one or more pivoting arms in such embodiments to guide the braking pad as it is deployed and retracted.

It is noted that though shown in a rounded rectangular shape in FIG. 1A, the braking pad 116 may be formed into various shapes, including narrower or wider rectangles, a square shape, a round or circular shape, and the like. In addition, the braking pad 116 may have a polygonal shape and/or incorporate one or more curves. The variety of shapes allows the braking pad 116 to more easily be incorporated into the structure of a vehicle. It is noted that the braking pad 116 may come in one or more separate portions or pieces which individually attach to the actuator 112 in some embodiments.

The braking pad 116 may also be various sizes. The size may be determined by the size and/or weight of the vehicle in which the master braking system is used. In one exemplary embodiment, such as for a passenger vehicle, the braking pad 116 may be 3 ft×4 ft. Alternatively, the braking pad 116 may be 2 ft×4 ft, or other sizes.

The braking pad 116 may comprise various substances. In one or more embodiments for example, the braking pad 116 may comprise one or more types of synthetic or natural rubber. The rubber is advantageous in that it “grips” the road surface due to its properties. It is contemplated that other substances may be used as well. For example, various plastics may be used. The substances may at least somewhat flexible in one or more embodiments. A flexible braking pad 116 may be advantageous in that it may better conform to a road surface. The braking pad 116 may have a texture 144 to grip various road surfaces, such as shown in FIG. 1B. For example, the braking pad 116 may have a tread on its road-facing surface like the that of a tire tread.

It is contemplated that a rigid braking pad 116 could also be used. For example, a rigid braking pad 116 having elements which engage the road surface (e.g., one or more spikes or the like) may be used. It is noted that a flexible or resilient braking pad 116 may also have one or more rigid or flexible spikes extending therefrom. For example, one or more metal or hard plastic spikes may extend from the braking pad 116 in some embodiments.

In some embodiments, the master braking system may include a support 128 which mounts a braking pad 116 to an actuator 112, such as the plate shown in FIG. 1A. The support 128 may be configured to hold and/or provide a structure to mount the braking pad 116 in one or more embodiments. The support 128 may be located between the deployment member 132 and braking pad 116. In this manner, the braking pad 116 can be mounted to the deployment member 132 via the backing support 128. It is noted that in some embodiments, a support 128 need not be provided because it is contemplated that the braking pad 116 may be attached to the deployment member 132 directly, if desired.

The support 128 may be configured to help ensure the force of the deployment member evenly applies through the braking pad 116 to the road surface. For example, as shown in FIG. 1A, the support 128 is a planar structure to which the braking pad 116 may attach. Since the road surface may be generally planar, when deployed, the support 128 applies the braking pad 116 to the road surface such that as much of the braking pad 116 as possible may contact the road surface to slow or stop a vehicle. The ends of the support 128 may optionally curve upward in some embodiments to cause the ends of the braking pad 116 to be curved upward when mounted to the support. In this manner, the risk of the support 128 “digging into” the road surface when deployed may be reduced.

It is contemplated that the support 128 may have elements which help evenly distribute the force provided by an actuator 112 to the braking material 116. For example, in FIG. 1A, the support 128 comprises a first support 128A and a second support 128B with the first smaller support being used to distribute the force to an intermediate area larger than that of the deployment member 132 but not as large as the overall support 128.

The first support 128A and second support 128A have been shown in particular configurations, however, it is contemplated that force distribution elements of the support 128 may have various configurations. For example, the support 128 may comprise one or more elongated members which extend radially outward from a central portion of the support 128 where the support meets the deployment member 132 of an actuator 112. In another embodiment, the support 128 may comprise a frame comprising one or more elongated members generally formed to the peripheral shape of the braking material 116. One or more cross members may support the interior area of the braking material 116.

In one or more embodiments, the support 128 may have a larger peripheral size than the deployment member 132. This is beneficial in that such a configuration permits larger braking pads 116 to be supported or attached to the actuator 112, which increases the amount of braking pad 116 that can contact a road surface. For instance, as shown in FIG. 1A, the braking pad 116 extends beyond the periphery of the deployment member 132, but remains supported by the support 128.

It is noted that the braking pad 116 may be integrally formed with an internal or integral support 128 in some embodiments. For example, the braking pad 116 may be formed with one or more portions of increased rigidity to provide the functionality of a support integral with the braking pad.

In other embodiments, the support 128 may have one or more mounts for attaching a braking pad 116. The mounts 136 may be configured to allow the braking pad 116 to be removed and reattached in one or more embodiments. This is beneficial in that a worn, damaged, or otherwise undesirable braking pad 116 may be removed and replaced. In addition, braking pads 116 comprising one or more distinct substances may be detached and attached as desired using the mounts. For example, a first braking pad 116 may be used for some types of road surfaces (e.g., asphalt) while another braking pad may be used for other types of road surfaces (e.g., dirt roads). Additional information regarding the mounts will be provided further below.

FIG. 1B illustrates another exemplary master braking system. In this embodiment, the master braking system may also comprise an actuator 112, braking pad 116, and power source 108. Here, the power source 108 may comprise a compressor 104 and a first reservoir 120A. An optional second reservoir 120B may also be provided, as will be described further below. As can be seen, or more conduits 124 may connect components of the power source 108 to one another, to the actuator 112, or both.

The gas within the first reservoir 120A may be pressurized by a compressor 104 in one or more embodiments. For example, as shown in FIG. 1A, the compressor 104 may be connected to the first reservoir 120A to pump gas into the reservoir thereby pressurizing the first reservoir. It is contemplated that the compressor 104 may be onboard a vehicle. Alternatively or in addition, the compressor 104 may be external to the vehicle. In these embodiments, the compressor 104 may be connected to pressurize the first reservoir 120A and disconnected prior to moving the vehicle. One advantage of the onboard embodiment is that the compressor 104 may continue to provide pressurization even when the vehicle is moving or away from another pressurization device. In this manner, the master braking system may be deployable more times than without an onboard compressor 104. It is noted that the first reservoir 120A may have sufficient capacity to allow repeated deployments of the master braking system without having to be re-pressurized in one or more embodiments.

In operation, gas may be released from the first reservoir 120A and travel to the actuator 112 via one or more conduits 124. The pressure of the gas may then cause the actuator 112 to extend, deploying the braking material 116. One or more valves 140 may be used to contain the gas within the first reservoir 120A and then to release the gas when desired.

After the braking pad 116 has been deployed, it may be retracted for storage, subsequent re-deployment, or both. Retracting the master braking system also disengages the master braking system allowing the vehicle to move freely once again. In one or more embodiments, retracting the braking pad 116 causes gas to leave the actuator 112. This gas may be returned to the first reservoir 120A to restore at least some of the pressurization lost in deploying the braking pad 116. The valve 140 may be opened to permit this re-pressurization. Alternatively, the gas may be exhausted to the environment in some embodiments.

In addition, the gas may return to a second reservoir 120B if such a reservoir is provided. It is noted that the second reservoir 120B is optional may not be included in every embodiment. Referring to FIG. 1B, if a second reservoir 120B is not provided, the conduits 124 connecting the second reservoir to the actuator 112 and first reservoir 120A need not be provided either and any openings servicing such conduits would not be provided or would be sealed.

Where provided, the second reservoir 120B may have a connection to the actuator 112 and the first reservoir 120A, such as the conduits 124 shown in FIG. 1B. In this manner, gas may return from the actuator 112 to the second reservoir 120B when the braking pad 116 is retracted. This gas may increase pressure in the second reservoir 120B in one or more embodiments.

The gas in the second reservoir 120B may then be used in deploying of the braking pad 116. For example, gas from the first reservoir 120A, the second reservoir 120B, or both may be sent to the actuator 112 to deploy the braking pad 116. Alternatively, the gas in the second reservoir 120B may be transferred to the reservoir 108 via a connection between the reservoirs such a conduit 124 between the reservoirs. One or more valves may be used to control the transfer of gas between the first and second reservoirs 120A,120B in one or more embodiments. For example, when pressure in the second reservoir 120B is sufficient to pressurize the first reservoir 120A, the valve may release the gas from the second reservoir to the first reservoir.

In this manner, the second reservoir 120 may be used to pressurize the first reservoir 108. This is advantageous in that it reduces the amount of pressurization that would need to be provided by a compressor 104 or other pressurization device. In addition, the added pressure can allow the reservoir 108 to deploy the braking pad 116 one or more additional times. It is noted that the second reservoir 120 may have a smaller volume than the first reservoir 108. In this manner, a smaller amount of gas can pressurize the second reservoir 120.

As can be seen in FIG. 1C, a power source 108 may power multiple actuators 112 in some embodiments. Similar to above, the connection between the power source 108 and an actuator 112 may pass through one or more valves 140 which may meter, turn on, turn off, or otherwise control energy transfer from the power source 108 to an actuator 112. For example, the valve 140 may be a gas or fluid valve which controls the rate at which gas or fluid is transferred to an actuator 112. Likewise, in an electrical embodiment, the valve 140 may be an electrical component which turns on, turns off, or regulates the flow of electricity to an actuator 112.

FIG. 1C illustrates that the number of actuators 112 for each power source 108 may vary, depending on the capacity of the power source (i.e., the ability of the power source to power the number of actuators). As can be seen, there may be one, two, three, or n number of actuators 112, where n is a positive integer. Each actuator 112 may be connected via its own valve 140. Alternatively, multiple actuators may share a valve. For example, where multiple actuators 112 are used to deploy one braking pad, these actuators 112 may share a valve 140 so as to evenly deploy the braking pad.

The number of actuators 112 for a particular vehicle may be determined based on characteristics of the vehicle. For example, heavier or larger vehicles may have more actuators 112 than smaller or lighter vehicles. To illustrate, an 18-wheeler's cab or trailer may require many more actuators 112 (and braking pads) to provide sufficient braking force due to the size and weight of such a vehicle, while a passenger vehicle may require fewer actuators 112 (and braking pads). Alternatively or in addition, the number of actuators 112 may be determined by the size of the braking pad to be used. For example, a smaller braking pad may be deployed with sufficient road surface contact by a single actuator 112, while a larger braking pad may require additional actuators to ensure the surface of the braking pad properly (e.g. substantially evenly) contacts the road surface.

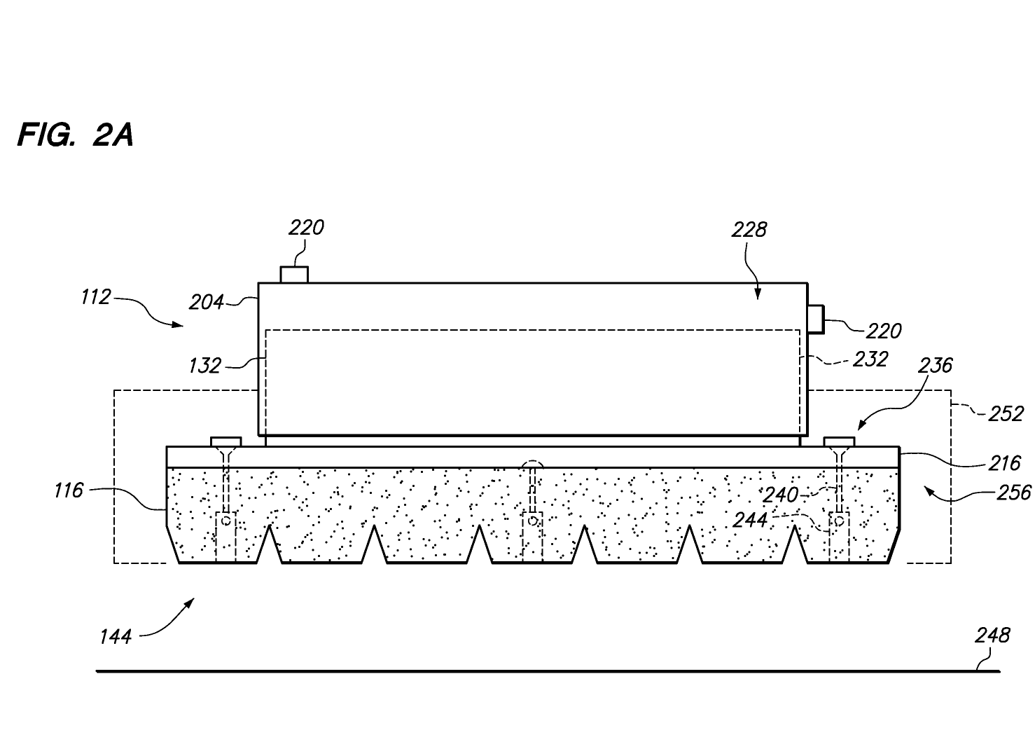

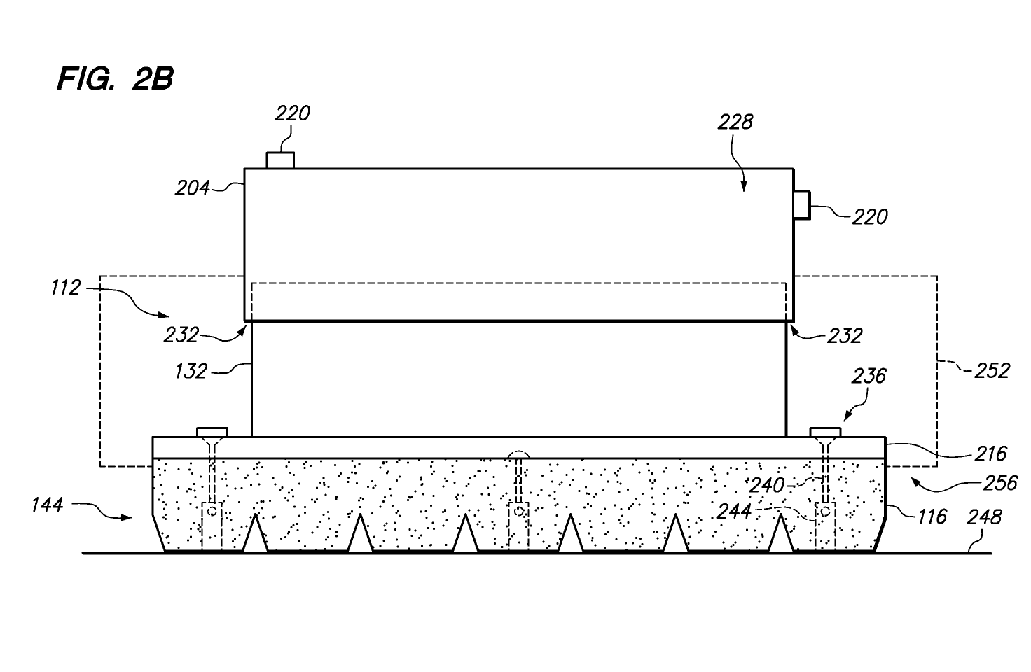

An exemplary actuator 112 and braking pad 116 will now be further described with regard to FIGS. 2A-2B. FIG. 2A illustrates the actuator 112 and braking pad 116 in retracted state while FIG. 2B illustrates the actuator and braking pad in an extended or deployed state. As shown, the master braking system comprises a body 204 and a deployment member 132 that may move relative to the body. One or more braking pads 116 may be mounted to the deployment member 132 to move with the deployment member. In one or more embodiments, the deployment member 132 may extend to deploy the braking pad 116 to a road surface 248, and retract to move the braking pad away from the road surface, or both.

In one or more embodiments, the body 204 may form a chamber 228 that accepts at least a portion of the deployment member 132. The deployment member 132 may be movable within the chamber 228. The chamber 228 may have an open portion that is enclosed by the deployment member 132. For example, as shown, the chamber 228 has an open bottom which is enclosed by the top end of the deployment member 132 in FIG. 2A. The body 204 and deployment member 132 may be configured to form a seal. In this manner, gas entering the chamber 228 may efficiently force the deployment member 132 outward from the body 204 without escaping. To illustrate, as shown in FIG. 2A, a seal may be formed at the edge(s) 232 of the deployment member 132.

The actuator 112 may comprise a deployment mechanism and a retraction mechanism to respectively deploy and retract the braking pad 116. The deployment mechanism, retraction mechanism, or both may operate in concert with other elements of the master braking system (such as a power source, compressor, and/or one or more reservoirs), as will be described further below.

In one or more embodiments, the deployment mechanism may comprise one or more gas ports 220 which allow gas to flow into the chamber 228, out of the chamber, or both. As shown in FIG. 2A for instance, the gas ports 220 are externally accessible on the body 204 and provide a connection to the chamber 228 through which gas may flow.

One or more gas ports 220 may connect the chamber 228 of the actuator 112 with a source of pressurized gas, such as the first or second reservoir. Referring back to FIG. 1B for example, pressurized gas may flow from the first reservoir 120A, second reservoir 120B, or both via one or more conduits 124, through one or more gas ports 220 to reach the chamber 228. At the chamber 228, the pressurized gas deploys the braking pad 116 by forcing the deployment member 132 outward from the actuator's body 204. This is shown in FIG. 2B which illustrates the deployment member 132 in an extended position. It is noted that multiple gas ports 220 may be used to deliver gas to the chamber 228. The use of multiple gas ports 220 can help distribute the gas within the chamber 228 to help ensure that the deployment member 132 deploys evenly and as desired.

The gas ports 220 may have a valve in one or more embodiments which only permits flow of gas in one direction. In this way, one or more gas ports 220 may be configured to only allow gas into the chamber 228 or out of the chamber. For example, a one way gas port 220 may allow gas into the chamber 228 to deploy the deployment member 132. In this embodiment, because the gas cannot escape out of the chamber 228, the deployment member 132 may be held in place at a deployed or extended position. This allows the master braking system to apply braking force for a period of time. It is noted that the valve of a gas port may be controlled by a control input or system of the master braking system to ultimately allow a driver/user or device to control the actuator 112.

In one or more embodiments, the master braking system may include a return mechanism which returns the system from a deployed state to a non-deployed state. Typically, this will occur by retracting the braking pad 116 such as by moving the braking pad away from a road surface 248.

The return mechanism may have various configurations. For example, the return mechanism may comprise a biasing device, such as a spring, which provides a force that retracts the braking pad 116. It is contemplated that one or more biasing devices may be used to retract the braking pad. Multiple biasing devices may be used to provide the force necessary to retract braking pads 116 of various weights if necessary.

The biasing device may be stretched when the braking pad 116 is deployed. In this manner, once the force, such as pressurized gas, used to deploy the braking pad 116 is released the biasing device may contract and return the braking pad to a retracted position, such as shown in FIG. 2A. It is noted that multiple springs may be used, as briefly discussed above. For instance, in addition or instead of a centrally located spring, one or more springs could be located at the sides (or other locations) of the deployment member 132. In this manner, the biasing devices can work to retract the braking pad 116 by applying their force to various portions of the deployment member 132.

In addition or instead of one or more biasing devices, it is contemplated that the return mechanism may employ other components to retract the braking pad 116. For example, the braking pad 116 may be connected to a counterweight and one or more cables/pulleys or the like which bias the braking pad (and the deployment member 132) towards a retracted position. It is contemplated that a separate electrical actuator or motor may be used to retract the biasing material 116 as well. For example, an electrical actuator or motor may be connected to a portion of the deployment member 132 and be used to retract the deployment member. In another example, the same actuator(s) 112 that deployed the braking pad 116 may be reversed to retract the braking pad.

To illustrate, it is contemplated that one or more gas ports 220 may be used to retract the braking pad 116. For instance, suction may be applied to one or more gas ports 220 to remove gas from the chamber 228. As this occurs, the deployment member 132 may retract into the chamber 228 thus retracting the braking pad 116. Suction may be applied to one or more two-way gas ports 220 or to one or more gas ports that allow flow of gas out of the chamber 228. A pump, vacuum, or the like may be used to remove gas from the chamber 228. The gas ports 220 may then be closed (such as by a valve) to hold the braking pad 116 in a retracted position.

In one or more embodiments, an optional enclosure 252 may be provided. The enclosure 252 may surround at least a portion of the braking pad 116 to protect the braking pad 116. The enclosure 252 may surround or enclose other components of the master braking system as well. For example, the enclosure 252 may enclose at least a portion of the deployment member 132, support 216, and/or body 204.

The enclosure 252 may provide a structure which protects components of the master braking system. As can be seen in FIG. 2A for example, the enclosure 252 encloses the braking pad 116 when the braking pad is retracted. This protects the braking pad 116 from physical damage (from rocks and other debris) as well as from dirt, dust, and the like which the braking pad would frequently encounter when mounted at the underside of a vehicle.

The enclosure 252 may protect moving portions of the master braking system as well. For example, the deployment member 132 may be protected by the enclosure 252. For instance, the edge 232 where the deployment member 132 meets the body 204 may be within and protected by the enclosure 252. In this manner, the enclosure 252 prevents dirt, debris, and the like from reaching this area of the master braking system. Such dirt and debris may otherwise interfere with the operation of the deployment member 132 such as by disrupting the seal at the edge 232 of the deployment member. In addition, the enclosure 252 also prevents physical impacts to this area of the master braking system thus protecting the master braking system from physical damage. This protection is beneficial in that the master braking system is typically positioned in proximity to a road surface where it will likely encounter hazards such as dirt and debris as well as physical impacts. In addition, the master braking system may be travelling at moderate to high speed when its vehicle is being driven, thus exacerbating the risk of damage from dirt, debris, physical impacts, and the like.

It is contemplated that the enclosure 252 may substantially or fully enclose the braking pad 116 (and thus the support 216 and deployment member 132 as well) in one or more embodiments, when the braking pad is retracted. For example, the enclosure 252 may have a bottom portion 256 that is open to allow the braking pad 116 to deploy therefrom. In this embodiment, only the braking pad 116 (which will typically be resistant to damage) may be exposed. Alternatively, the enclosure 252 may have a bottom 256 portion that may open and/or close. In this way, when the braking pad 116 is retracted the enclosure 252 may be closed to provide its protective benefits. The enclosure 252 may open when the braking pad 116 is deployed to allow the braking pad to contact a road surface 248.

In one embodiment, the enclosure 252 may include one or more doors that can open and close on one or more pivots or hinges. Alternatively, the enclosure 252 may have a breakaway portion which is moved aside by deployment of the braking pad 116. For example, a breakaway cover may fall away when the braking pad 116 is deployed. In addition, it is contemplated that the enclosure may have a portion which tears or breaks upon deployment. For example, the enclosure 252 may have a breakable rigid or flexible membrane or the like which is punctured or broken by the braking pad 116 when deployed. Typically, the portion of the enclosure 252 that opens, if provided, will be located at the bottom portion 256 of the enclosure so that the braking pad 116 can extend downward from the enclosure and toward a road surface 248 when deployed.

Deployment and retraction of the braking pad 116 will now be described with regard to FIGS. 2A-2B. As stated, FIG. 2A illustrates the master braking system in a retracted state. In general, in the retracted state, the actuator 112 of the master braking system will be retracted, thus positioning the braking pad 116 away from the road surface.

As can be seen from FIG. 2A, the deployment member 132 is within the chamber 228 at a position where the braking pad 116 is not in contact with the road surface 248. The distance between the braking pad 116 and road surface 248 shown is exemplary and may vary in different embodiments of the master braking system. In one or more embodiments, the braking pad 116 may be retracted such that it is at or near or flush with the bottom of a vehicle. In this way, the vehicle's ground clearance is not obstructed by the master braking system.

It is noted that the braking pad 116 may be retracted to various distances from a road surface 248. For example, the braking pad 116 may be retracted a small distance from the road surface 248 to allow rapid deployment to the road surface. Alternatively, the braking pad 116 may be retracted a relatively larger distance so as to reduce or eliminate any obstruction to the vehicle's ground clearance. In embodiments having an enclosure 252, the braking pad 116 may retracted to a position where the braking pad is substantially or completely within the enclosure. Doors or other closable structures of the enclosure 252 may be closed to protect the master braking system in the retracted state, such as described above.

The braking pad 116 may be held in the retracted state in various ways. For example, in one embodiment, a biasing device may apply a force to hold the braking pad 116 in a retracted position, such as described above with regard to FIG. 2A. Alternatively, one or more clips, clamps, pins, or other fasteners may be used to hold the braking pad 116 in a retracted position. In one embodiment, the door, cover, or other closing portion of the enclosure 252 may hold the braking pad 116 in a retracted position. It is contemplated that such holding mechanism may be configured to be overcome by the force used to deploy the braking pad 116. Alternatively or in addition, the holding mechanism may be configured to release when the braking pad 116 is deployed.

FIG. 2B illustrates a master braking system in a deployed state. As can be seen, the braking pad 116 may contact a road surface 248 when the master braking system is in a deployed state. The contact between the road surface 248 and braking pad 116 is used to provide the master braking system's powerful stopping force. In general, the actuator 112 may extend outward to cause the master braking system to be in a deployed state, as shown in FIG. 2B. For instance, in the deployed state, the deployment member 132 may extend outward from the body 204. The braking pad 116 may accordingly extend from the enclosure 252 to contact the road surface 248.

To achieve the deployed state, gas may be forced into the chamber 228. As the gas fills and pressurizes the chamber 228, the deployment member 132 and braking pad 116 may be forced toward the road surface 248 as shown in FIG. 2B. The release of gas from a compressor or reservoir into the chamber 228 may be rapid to rapidly deploy the braking pad 116. This allows the braking pad 116 to quickly contact the road surface 248 and slow or bring the vehicle to a stop. In fact, in an emergency situation, the release of pressurized gas may be such that deployment of the braking pad 116 is virtually instantaneous.

Once the braking pad 116 contacts the road surface 248, force may continue to be applied to increase the grip or friction between the braking pad 116 and road surface 248. For example, gas may continue to enter the chamber 228 to increase the force applied by the braking pad 116 to the road surface 248. In one or more embodiments, this may compress the braking pad 116 somewhat. It is contemplated that varying amounts of gas pressure may be used to provide varying amounts of braking force in one or more embodiments. High or full pressurization may be used to stop a vehicle as quickly as possible, such as in an emergency situation.

The gas within the chamber 228 may be held in the chamber to continue to apply the braking pad 116 to the road surface 248. As discussed above, this may occur through the use of one-way gas ports 220, valves, or the like. In this manner, the braking pad 116 may be applied to the road surface 248 for a period of time to slow and/or stop a vehicle.

It is contemplated that a ratcheting mechanism may be used to hold the braking material 116 in an extended position in some embodiments. For example, the deployment member 132 and body 204 may be connected by a ratchet gear and pawl assembly within the chamber 228. In this way, as the braking material 116 is deployed the gear and pawl of the ratcheting assembly prevent the braking material (and deployment member) from moving back to a retracted position. The braking material 116 may thus be held against the road surface 248 until the ratcheting mechanism is released, such as by motorized or mechanized movement of the pawl to disengage the gear of the ratcheting mechanism. It is noted that a ratcheting mechanism may be employed in the opposite direction for instance to hold the braking material 116 in a retracted position.

If desired, the braking pad 116 may be left deployed for extended periods of time. For example, to prevent theft of a vehicle the braking pad 116 may be deployed overnight or for various other periods of time. It is contemplated that the master braking system's control system may be separate from that of the vehicle's. In this manner, if the vehicle's keys are stolen, an unauthorized person can not disengage the master braking system even with access to the vehicle.

Alternatively, the braking pad 116 may be deployed momentarily to slow a vehicle or to stop a vehicle. The braking pad 116 may subsequently be retracted to allow the vehicle to move freely once again. For example, in an emergency situation, the driver may desire to rapidly stop his or her vehicle. Once stopped, the braking pad 116 may be retracted to allow the vehicle to be moved. This allows the driver to rapidly stop and then to move his or her vehicle, such as to a safe area.

The gas within the chamber 228 may be allowed to escape to retract the braking pad 116 from a deployed state. For instance, as described above, gas may be permitted to return to a reservoir of the master braking system. Alternatively, gas may be exhausted to the environment. It is noted that one or more valves or the like may be used to release the gas. The release of the gas lowers the pressure within the chamber 228 allowing the deployment member 132 to be moved into the chamber 228. Once the pressure is low enough, the force form a biasing device may retract the deployment member 132 and braking pad 116 to a retracted position.

It is contemplated that the master braking system may utilize a plurality of actuators 112 in some embodiments. Each actuator 112 may have the same configuration or a different configuration. For example, one actuator 112 may be pneumatically driven while another actuator is an electrical actuator. Accordingly, each actuator 112 may share a power source or have its own power source. For example, two (or more) actuators 112 may utilize the same reservoir or each have their own reservoir.

The plurality of actuators 112 may provide additional deployment force. In addition, it is contemplated that the actuators 112 may function as backups in the case one (or more) actuators 112 fail. Each actuator 112 may have its own braking pad 116 in one or more embodiments. Alternatively, multiple actuators 112 may be associated with a single braking pad 116 in some embodiments. For example, with a braking pad 116 having a larger surface area or size, multiple actuators 112 may be used to ensure even contact and/or provide adequate deployment force between the braking pad 116 and road surface 248.

FIGS. 2A-2B also illustrate how braking pad 116 may be mounted to an actuator 112. As discussed briefly above, one or more mounts 136 may be used to attach the braking pad 116. A braking pad 116 may be permanently or removably attached in various embodiments of the master braking system.

In general, the mounts 136 allow a braking pad 116 to be connected to the deployment member 132 of the actuator 112. This may occur by attaching the braking pad 116 to a support 128 which is attached to the deployment member 132 such as discussed above.

The mounts 136 may comprise one or more mechanical fasteners 240 which hold the braking pad 116 to the support 128. For example, one or more threaded connectors, pins, rivets, clips, clamps, or the like may be used in one or more mounts. In FIGS. 2A-2B for example, pins having enlarged heads secure the braking pad 116. It can thus be seen that various fasteners 240 may extend into or through the support 128 to secure the braking pad 116.

One or more portions of the braking pad 116 may be shaped to allow at least a portion of a mount to connect to the support 128 without contacting the road surface, when the braking pad is deployed. For instance, as shown in FIGS. 2A-2B, the braking pad 116 may comprise one or more recessed portions 244 to accept a fastener 240 while keeping the fastener away from the road surface. In another exemplary embodiment, the braking pad 116 may have a textured or uneven surface 144, such as a surface having various peaks and valleys. In yet another example, the braking pad 116 may be textured to have a tread-like surface similar to that of a tire. One or more fasteners 240 may be positioned at the valleys or low points of the braking pad 116 to secure the braking pad without contacting the road surface when the braking pad is deployed.

It is noted that the textured surface 144 may be on the side of the braking pad 116 that faces the road surface. A textured surface 144 may be on both sides of the braking pad in some embodiments. In this manner, when one side is worn or damaged, the braking pad 116 may be flipped and used for an additional period of time. Though beneficial, it is contemplated that the braking pad may have a smooth non-textured surface in some embodiments.

It is noted that various components of the master braking system may be removable for maintenance and/or repair. For example, components of the master braking system may be held together by removable fasteners such as screws and the like. This removability may be used to change the braking pad 116. For instance, the support 128 may be removable from the deployment member 132 in some embodiments. In this manner, the support 128 and any associated braking pad 116 may be removed to allow different braking pad to be used with the master braking system.

Likewise, the braking pad 116 itself may be removable via the mounts 136. For example, the mounts 136 may utilize threaded fasteners 240 which may be “unscrewed” to release the braking pad and “screwed in” to secure the braking pad. As another example, the mounts 136 may utilize rivets as fasteners 240. In such case, the rivets may be removed to release the braking pad 116 and new rivets used to secure the braking pad. The same securing and releasing may be occur with the various mounts/fasteners that may be used with the master braking system.

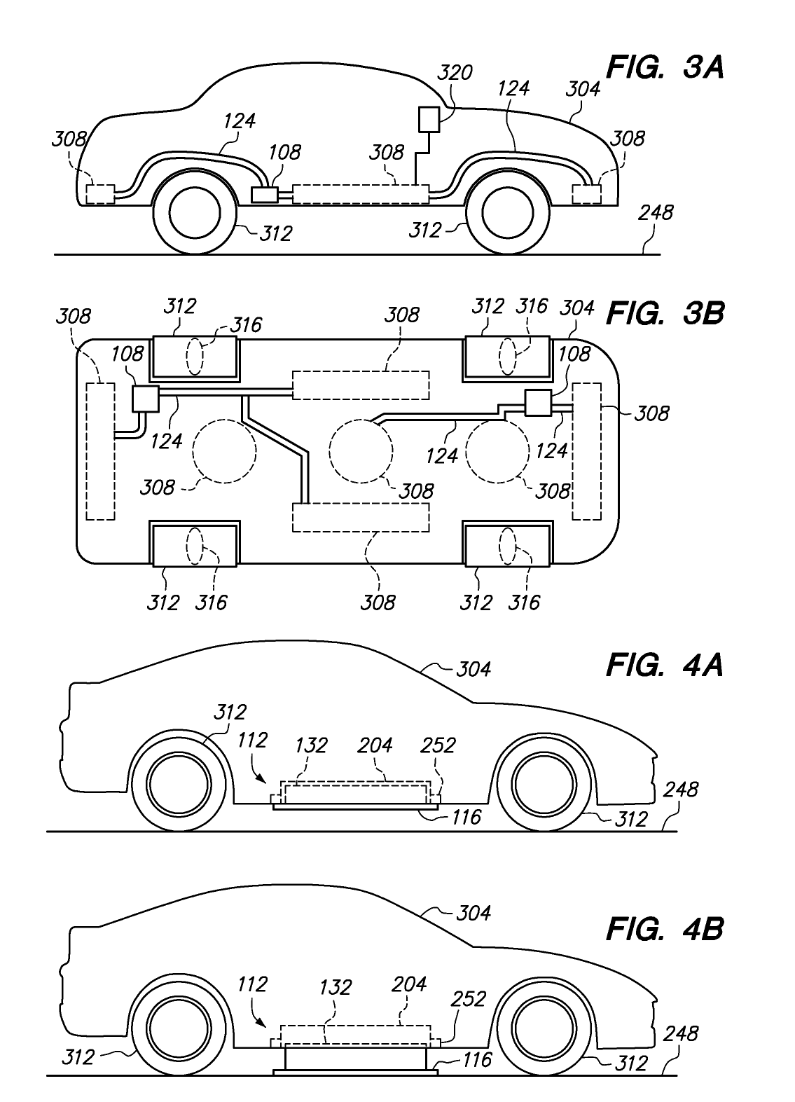

Installation of a master braking system on a vehicle will now be described with regard to FIGS. 3A-3B, which respectively illustrate a side view and bottom view of an exemplary vehicle 304. The vehicle 304 may have the master braking system or components thereof located at various locations. For example, the areas 308 indicated by the dashed lines in FIGS. 3A-3B show exemplary locations where the braking pad and actuator of the master braking system may be mounted. Other locations may be used as well.

As can be seen, the braking pad may be positioned in areas 308 at the front, back, and/or sides of a vehicle. In addition, the braking pad may be at an area 308 positioned centrally on the vehicle. The braking pad may then deploy from such area(s) 308.

It is noted that the braking pad may be positioned such that, when deployed, the vehicle 304 continues its movement in a controlled way. For example, braking pad may be at areas 308 at both sides of the vehicle 304 to prevent the vehicle from moving from one side to another when the braking pad is deployed. A braking pad may be at an area 308 at the back of the vehicle such that the vehicle pulls the braking pad rather than pushes the braking pad. In addition, placing the braking pad rearward helps prevent the vehicle from flipping. As will be described further below, it is contemplated that braking pads at various areas 308 of the vehicle may be deployed from one or more of the areas based on the situation in which braking is to occur.

Referring to FIG. 3A, it can be seen that the power source 108 for the master braking system may be positioned at the bottom of the vehicle 304. The power source 108 may connect to one or more actuators 112 via one or more conduits 124. As discussed, the conduits 124 may be bent, curved, or otherwise manipulated to reach to/from various locations of the vehicle 304. In this manner, the power source 108 (or multiple power sources) may be mounted at various locations. For example, a power source 108 may be at the engine compartment or trunk or elsewhere in a vehicle 304.

FIG. 3A also shows an input control 320 which may be used to control the master braking system. As will be described further below, the input control 320 may be a button, switch, knob, pedal, or other control surface/device that allows a user to control the operation (i.e., deployment and/or retraction) of the master braking system. As shown in FIG. 3A, the input control 320 is positioned within the passenger compartment of the vehicle 304. Typically, the input control 320 will be positioned within reach of the driver's hands or feet. It is noted that though one input control 320 is illustrated, a plurality of input controls may be provided such as to allow the master braking system's controls to be more accessible, especially in emergency situations.

Referring to FIG. 3B, the contrast between traditional braking systems and the master braking system can be seen. In traditional systems, the circular shape of the vehicle's tires 312 create a small contact surface 316 between the tires and the road surface. Typically, such contact surface 316 is six inches or less. Therefore, an entire vehicle is traditionally stopped by four small contact surfaces 316.

The master braking system's braking pad is capable of providing a substantially increased contact surface. This is highly advantageous in terms of reducing a vehicle's stopping distance in both normal and hazardous road conditions. In fact, the contact surface provided by the master braking system may be one or multiple orders of magnitude larger than that of traditional systems. For example, the braking pad may be of a similar size and shape as the areas 308 shown in FIG. 3B. As can be seen, this is a vast increase to the amount of contact surface 316 provided by traditional braking systems. In fact, one area 308 of braking pad may provide more contact surface than all four (or more) of a vehicle's tires 312. In addition, it is contemplated that the braking pad may complement (i.e., increase) the contact surface provided by a vehicle's tires 312 because the tires may continue to contact the road surface along with the braking pad.

FIGS. 4A-4B illustrate the master braking system in operation with respect to a vehicle. In FIG. 4A, the master braking system is in a retracted state and, as can be seen, the vehicle 304 may move freely. In FIG. 4B, the master braking system is in a deployed state to slow and/or stop the vehicle 304 by contact between its braking pad 116 and the road surface 248.

FIG. 4A shows that the master braking system may intrude minimally into the ground clearance of a vehicle 304. For example, as shown a small portion of the master braking system, such as its braking pad 116 may protrude into the ground clearance area of a vehicle 304. It is contemplated that the master braking system may be mounted such that it does not intrude into the ground clearance area. For example, the master braking system may be mounted higher such that the braking pad 116 is above or even with the bottom of the vehicle's body.

When deployed, the braking pad 116 may be moved to contact the road surface 248 by a deployment member 132, as discussed above. FIG. 4B shows that the braking pad 116 adds to the contact surface between the vehicle 304 and the road surface 248. In other words, the braking pad 116 increases the contact area with the road surface that is provided by the tires.

As such, the deployment member 132 or of the master braking system may be configured to cause the braking pad 116 to provide braking force (through contact with the road surface 248) without lifting the vehicle 304 so as to cause loss of traction or contact with the road surface by the vehicle's tires 312. This is advantageous because the tires 312 may continue to provide their braking force. In addition, the tire contact with the road surface 248 allows a user to continue to steer the vehicle.

It is noted that a variable amount of force may be applied by the actuator 112 in one or more embodiments. For example, an increased or large amount of force may be applied to quickly stop a vehicle 304, while a decreased or small amount of force may be applied to gradually stop a vehicle. This is beneficial in that it may prevent the vehicle 304 from skidding. It is noted that the actuator 112 may cycle the force applied such as to provide intermittent application of the braking pad 116 to the road surface 248. The cycling may be rapid and be used to reduce skidding or loss of vehicle control, if desired.

In FIGS. 4A-4B the master braking system has been mounted centrally on the vehicle 304. As stated above, the master braking system could be mounted at other areas of the vehicle 304 as long as the braking pad 116 is capable of contacting the road surface 248 when deployed. The mounting of the actuator 112 to a vehicle 304 may be achieved in various ways. For example, in one embodiment, the body 204 of the actuator 112 may be attached or mounted to a support or other structure of a vehicle 304. One or more mounts, such as elongated members, brackets, braces, and the like, may be used to connect the body 204 to the vehicle 304. In one or more embodiments, the actuator 112 may be mounted to a vehicle's main structural supports for added stability.

Though shown in use with a sedan-type vehicle, the master braking system may be used with a variety of vehicles. For example, the master braking system may be used with cars and trucks of various makes and models. The master braking system may also be used with on or off road vehicles. It is contemplated that the master braking system could be applied to vehicles having greater or less than four wheels as well. In addition, the master braking system may be used for consumer vehicles as well as other vehicles, such as cargo hauling vehicles, emergency vehicles, military vehicles, and/or law enforcement vehicles.

The master braking system may also be used with vehicles that are not self-propelled. For example, the master braking system may be applied to semi truck or other trailers which would be pulled by another vehicle. This is highly advantageous in that the master braking system, when deployed from a trailer, may help keep the trailer under control when braking rapidly. In addition, braking from the trailer may help slow or stop the truck or other vehicle hauling the trailer.

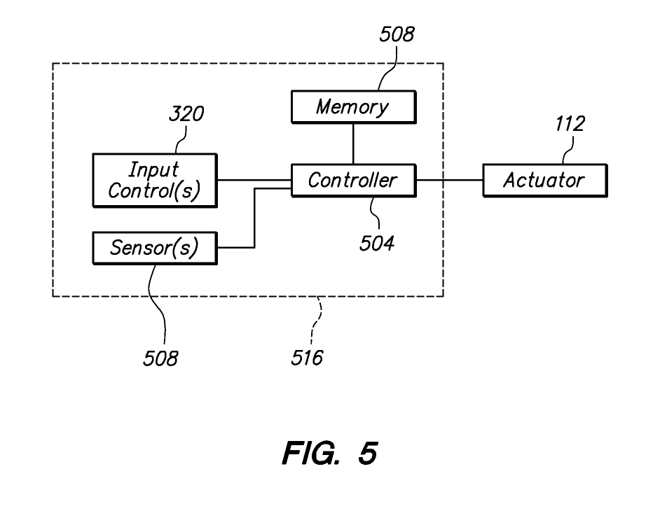

FIG. 5 is a block diagram illustrating exemplary control module 516 for a master braking system. As can be seen, the control module 516 may include a controller 504, memory 508, input controls 320, and sensors 508. Though shown in a particular quantity, it is noted that various quantities of these components may be provided in some embodiments. For example, redundancy or additional functionality may be provided by including one or more additional controllers, memory, input controls, sensors, or other components. In addition, it is noted that some components are optional and may not be included in every embodiment. For example, as will become apparent from the following, the control module 516 may not require a controller 504, sensors 508, or memory 508 in one or more embodiments.

In general, the control module 516 is configured to allow a user or a device to operate the master braking system. For example, the control module 516 may be used to control an actuator 112 such as to deploy and/or retract braking pad. In one or more embodiments, the control module 516 may control the actuator 112 by sending one or more signals to the actuator. Alternatively, the control module 516 may provide power (in varying amounts in one or more embodiments) to control the actuator 112. In one basic example configuration, the control module 516 may have an input control 320, such as a button, switch, lever, pedal, or the like, which signals the actuator 112 to extend or retract.

In one or more embodiments, the control module 516 may control individual actuators 112 or a plurality of actuators. Alternatively or in addition, a vehicle may have multiple control modules 516 to control various of its actuators 112.

It is noted that an input control 320 may have various configurations. For example, the input control 320 may be a button (as indicated above), a switch, knob, lever, or the like. The input control 320 may also or alternatively be configured as an input control of a vehicle 304. For example, the input control 320 may be a pedal, emergency brake lever, button, or switch of a vehicle 304.

The control module 516 may provide more advanced features in some embodiments. For example, the control module 516 may have one or more controllers 504, which may be one or more microprocessors, circuitry, or the like that controls an actuator 112. The controller 504 may execute machine readable code or instructions stored in a memory 508 and/or hard-wired into the controller itself. The memory 508 may also be used to store data required for the execution of the machine readable code or instructions.

The controller 504 may operate the master braking system's actuator in different ways depending on the situation and/or the input it receives. For example, in one embodiment, the controller 504 may rapidly deploy the braking pad where an emergency or similar situation occurs, and may gradually deploy the braking pad in other situations. To illustrate, if an input control 320 is rapidly activated (e.g., stomping on a brake pedal) the controller 504 may rapidly deploy braking pad to achieve the shortest stopping distance.

The amount of force applied to a road surface by the braking pad may also be adjusted based on how an input control 320 is activated. For example, rapidly or urgently activating an input control 320 may result in high or maximum force being applied, while a reduced level of force may be used in other situations.

In some embodiments, the controller 504 may determine whether or not to deploy the braking pad. For example, ordinary braking by stepping on a brake pedal may not deploy the braking pad while urgent or emergency braking may deploy the braking pad. The speed or urgency at which the brake pedal or other input control 320 may be determined by communication between the input control and the controller 504 and be used to determine whether or not the braking pad should be deployed. As can be seen, in this manner an existing input control 320 (e.g., a brake pedal) may be used to operate a vehicle's traditional systems as well as the master braking system.

In one embodiment, the controller 504 may receive input from one or more sensors 508 to control the deployment. The one or more sensors 508 may collect information regarding the vehicle's weight, speed, direction, pitch, yaw, rotation among other things. In addition, sensors 508 may collect information regarding road conditions, surface types, and the like. This information allows advanced control of the master braking system. For example, braking pad may be deployed from various areas of a vehicle depending on the vehicle's speed, direction, pitch, or the like.

To illustrate, braking pad at the rear of a vehicle may be deployed at high speed to help ensure the vehicle does not flip when the braking pad is deployed. In addition, braking pad at either or both sides of a vehicle may be deployed to control rotation of the vehicle. The amount of force applied may be increased based on road conditions, vehicle weight and speed, and other information. For instance, force may be increased when a vehicle is heavier and decreased when a vehicle is lighter. It is noted also that force may cease to be applied by the master braking system if it is determined by one or more weight sensors, that the vehicle's tires are starting to or have been lifted off the road surface.

It is contemplated that one or more sensors 508 may be used to detect other vehicles. In one embodiment, if another vehicle is too close to the user's vehicle, the controller 504 may automatically deploy the master braking system to prevent a collision. The deployment may occur based on the vehicle's speed in one or more embodiments. For example, one or more sensors 508 may determine the speed of the user's vehicle and/or nearby vehicles. If their speed and proximity indicate an imminent or high likelihood of collision, the controller 504 may deploy the master braking system.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. A braking system for a vehicle comprising:
an actuator comprising a deployment member configured to be movable between a retracted position and an extended position at a bottom portion of the vehicle, wherein the deployment member extends downward from the bottom portion of the vehicle in the extended position;
a braking pad attached to the deployment member, the braking pad configured to slow the vehicle through contact with a road surface;
to a reservoir configured to hold pressurized gas therein;
one or more conduits connecting the reservoir to the actuator; and
at least one input control within the vehicle, the at least one input control configured to accept user input to release the pressurized gas from the reservoir to the actuator.

2. The braking system of claim 1, wherein the at least one input control is further configured to accept user input to release the pressurized gas from the actuator.

3. The braking system of claim 1, wherein the actuator is configured to move the deployment member from the extended position to the retracted position, wherein the braking pad is not in contact with the road surface in the retracted position.

4. The braking system of claim 1 further comprising a compressor configured to provide the pressurized gas to the reservoir, wherein the compressor is connected to the reservoir by at least one of the one or more conduits.

5. The braking system of claim 1 further comprising an enclosure configured to surround at least a portion of the deployment member where the deployment member extends from a body of the actuator.

6. The braking system of claim 1 further comprising a support between the deployment member and the braking pad, the support having a peripheral size larger than the deployment member.

7. The braking system of claim 6, wherein the braking pad has a peripheral size larger than the deployment member.

8. A braking system for a vehicle comprising:
an actuator comprising a deployment member configured to be movable between a retracted position and an extended position at a bottom portion of the vehicle, wherein the deployment member extends downward from the bottom portion of the vehicle in the extended position;
a power source configured to power the actuator by providing energy selected from the group consisting of pneumatic energy, hydraulic energy, and electrical energy;
a braking pad attached to the deployment member, wherein the braking pad is configured to convert the vehicle's motion into heat via contact with a road surface, and to provide an increased contact surface area between the vehicle and the road surface relative to a contact surface area provided by one or more tires of the vehicle and the road surface; and
an input control configured to cause the deployment member to extend downward from the bottom portion of the vehicle to produce contact between the braking pad and the road surface.

9. The braking system of claim 8 wherein the actuator is centrally mounted at the bottom portion of the vehicle.

10. The braking system of claim 8, wherein the actuator is mounted at a rear end of the vehicle.

11. The braking system of claim 8, wherein the vehicle is a trailer.

12. The braking system of claim 8 further comprising an enclosure configured to enclose at least a portion of the deployment member where the deployment member extends from a body of the actuator.

13. The braking system of claim 8, wherein the enclosure encloses the braking pad, the enclosure comprising a bottom configured to open as the deployment member extends downward from the bottom portion of the vehicle.

14. A method for slowing a vehicle comprising:
providing a braking pad in a retracted position, the braking pad attached to a deployment member of an actuator at a bottom portion of the vehicle;
receiving an input indicating that the braking pad must be deployed;
extending a deployment member downward from the bottom portion of the vehicle to deploy the braking pad;
contacting a road surface with the braking pad; and
applying a force to the road surface through the braking pad and deployment member to slow the vehicle.

15. The method of claim 14 further comprising retracting the deployment member to the retracted position to raise the braking pad off the road surface.

16. The method of claim 14 further comprising receiving an input indicating that the braking pad must be retracted.

17. The method of claim 14 further comprising protecting the braking pad in the retracted position with an enclosure configured to form a barrier around the braking pad.

18. The method of claim 14 further comprising removing the braking pad from a bottom end of the deployment member and attaching a new braking pad to the bottom end of the deployment member.

19. The method of claim 14, wherein extending the deployment member comprises sending pressurized gas from a reservoir to the actuator.

20. The method of claim 19 further comprising pressurizing the reservoir by forcing gas into the reservoir.
